(19) United States
(12) Patent Application Publication
(10) Pub. No.: US 2018/0084804 A1
(43) Pub. Date: Mar. 29, 2018

(54) Process of producing beverage by fermenting cactus fruit and pitaya

(71) Applicants: Shui-Chen Huang, Kaohsiung (TW); Chang-Lu Hsu, Kaohsiung (TW); Jung-Lung Lo, Kaohsiung (TW); Yi-Jinn Chen, Kaohsiung (TW); Hui-Ting Chan, Kaohsiung (TW)

(72) Inventors: Shui-Chen Huang, Kaohsiung (TW); Chang-Lu Hsu, Kaohsiung (TW); Jung-Lung Lo, Kaohsiung (TW); Yi-Jinn Chen, Kaohsiung (TW); Hui-Ting Chan, Kaohsiung (TW)

(21) Appl. No.: 15/808,881

(22) Filed: Nov. 9, 2017

(51) Int. Cl. A23L 2/38; A23L 19/00

(52) U.S. Cl. CPC A23L 2/382; A23L 19/09; A23Y 2300/55; A23Y 2220/03; A23V 2002/00

(57) ABSTRACT

A process of producing beverage includes washing and drying cactus fruit and pitaya; juicing the cactus fruit to obtain juice of the cactus fruit and juicing the pitaya to obtain juice of the pitaya respectively; filtering the juice of the cactus fruit and the juice of the pitaya respectively; mixing the filtered juice of the cactus fruit and the filtered juice of the pitaya with water to obtain a solution; pouring yeast and gram-positive bacteria in the solution wherein the yeast is saccharomyces boulardii and the gram-positive bacteria includes lactobacillus acidophilus and bifidobacterium longum; and fermenting the solution until beverage is produced wherein fermentation temperature is between 26° C. and 35° C. and fermentation time lasts for 3 to 10 days.

### BACKGROUND OF THE INVENTION

### 1. Field of the Invention

The invention relates to process of producing beverage by fermenting and more particularly to a process of producing beverage by fermenting cactus fruit and pitaya (i.e., dragon fruit), the beverage being antioxidant.

### 2. Description of Related Art

A conventional process of producing cactus and vegetable based enzyme comprises cutting cactus and vegetable, selecting 1×10⁵−9×10⁵ CFU/ml of at least one of yeast, acetic acid, lactic acid, and fermentation starter as species, mixing the cut cactus and vegetable with the species to obtain a mixture, and adding sugar and the mixture to a container for fermentation for 150 to 200 days.

Another conventional process of producing wine by fermenting pitaya and siraitia grosvenorii comprises washing and cutting peeled pitaya, corn and siraitia grosvenorii to obtain a mixture, and adding yeast, water, sugar, and acid to the mixture for fermentation 3 to 5 months, thereby obtaining a first solution; mixing cut corn with water and sugar, and adding yeast to the mixture for fermentation 3 to 5 months, thereby obtaining a second solution; and boiling the first and second solutions and sealing same to produce wine.

However, these processes are complicated, nutrients in the finished product are lost, and the production time is excessively long. Thus, the need for improvement still exists.

### SUMMARY OF THE INVENTION

It is therefore one object of the invention to provide a process of producing beverage process of producing beverage comprising the steps of washing cactus fruit and pitaya with clean water; drying the clean cactus fruit and pitaya; juicing the cactus fruit to obtain juice of the cactus fruit and juicing the pitaya to obtain juice of the pitaya respectively; filtering the juice of the cactus fruit and the juice of the pitaya respectively; mixing the filtered juice of the cactus fruit and the filtered juice of the pitaya with water to obtain a solution; pouring yeast and gram-positive bacteria in the solution wherein the yeast is saccharomyces boulardii and the gram-positive bacteria includes lactobacillus acidophilus and bifidobacterium longum; and fermenting the solution until beverage is produced wherein fermentation temperature is between 26° C. and 35° C. and fermentation time lasts for 3 to 10 days.

The above and other objects, features and advantages of the invention will become apparent from the following detailed description taken with the accompanying drawings.

### BRIEF DESCRIPTION OF THE DRAWINGS

FIG. 1 is a flow chart illustrating a process of producing beverage by fermenting cactus fruit and pitaya according to the invention;

FIG. 2 is a chart of days versus values for anti free-radical DPPH activity before and after fermentation; and

FIG. 3 is a bar chart of days versus values for anti free-radical before and after fermentation.

### DETAILED DESCRIPTION OF THE INVENTION

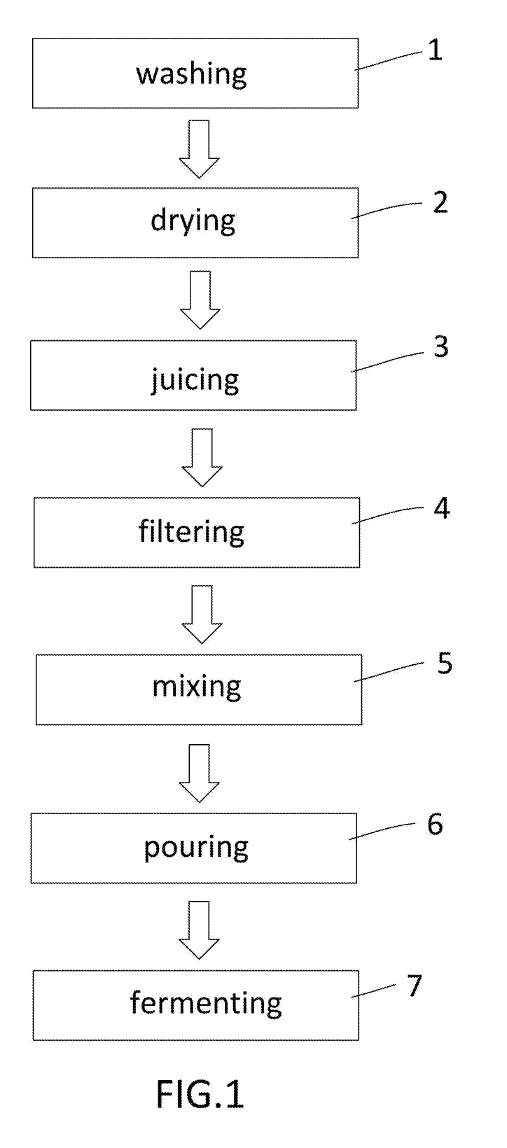

Referring to FIG. 1, a process of producing beverage by fermenting cactus fruit and pitaya in accordance with the invention illustrated. The process comprises the following steps:
Step 1: Washing cactus fruit and pitaya with clean water.
Step 2: Drying the clean cactus fruit and pitaya to remove water out of peels of both cactus fruit and pitaya.
Step 3: Juicing the cactus fruit to obtain juice of the cactus fruit and juicing the pitaya to obtain juice of the pitaya respectively.
Step 4: Filtering the juice of the cactus fruit and the juice of the pitaya respectively.
Step 5: Mixing the filtered juice of the cactus fruit and the filtered juice of the pitaya with water to obtain a solution wherein a volumetric ratio of the filtered juice of the cactus fruit, the filtered juice of the pitaya, and water is 0.05-0.1:1-5:1-5.
Step 6: Pouring yeast and gram-positive bacteria in the solution wherein the yeast is saccharomyces boulardii, the gram-positive bacteria includes lactobacillus acidophilus and bifidobacterium longum, and a volumetric ratio of saccharomyces boulardii, lactobacillus acidophilus, and bifidobacterium longum is 1-5:1-3:1-3.
Step 7: Placing the solution in a fermentation tank for fermentation until beverage is produced wherein fermentation temperature is between 26° C. and 35° C., and fermentation time lasts for 3 to 10 days.

The sugar free fermentation saves time and the beverage has a lower calorie.

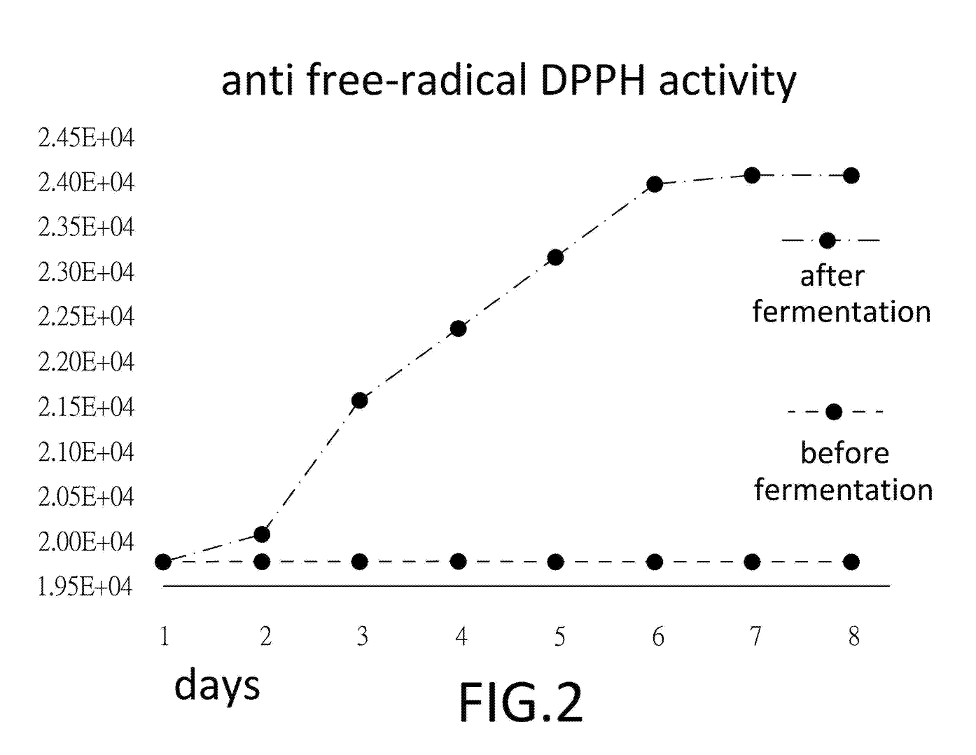

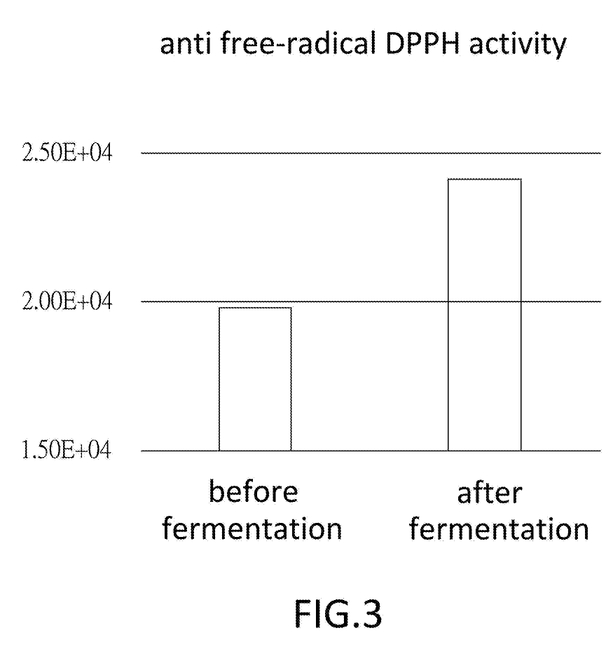

Referring to FIGS. 2 and 3, advantages of the process of the invention are shown in which FIG. 2 is a chart of days versus values for anti free-radical DPPH (2,2-diphenyl-1-picrylhydrazyl) activity before and after fermentation, and FIG. 3 is a bar chart of days versus values for anti free-radical DPPH activity before and after fermentation. Specifically, the solution before fermentation (called the solution) is compared with the beverage produced by fermentation (called the beverage) in a daily basis.

As shown in FIG. 2 specifically, in day 1, there is no difference between the solution and the beverage in terms of anti free-radical DPPH activity; in day 2, the anti free-radical DPPH activity of the beverage is greater than that of the solution; in each of days 3, 4, 5 and 6, the anti free-radical DPPH activity of the beverage is significantly greater than that of the solution as the day proceeds; and in days 7 and 8, the anti free-radical DPPH activity of the beverage is substantially no change in comparison with that of the beverage observed in day 6.

It is concluded that the anti free-radical DPPH activity of the beverage is significantly greater than that of the solution.

As shown in FIG. 3 specifically, the anti free-radical DPPH activity of the beverage is about two times of that of the solution.

The invention has the following characteristics: The beverage is antioxidant. Saccharomyces boulardii, lactobacillus acidophilus, and bifidobacterium longum do not exclude one another and may greatly increase anti free-radical DPPH activity of the production of the beverage. The beverage is full of nutrients. Fermentation time is greatly decreased. No sugar is added in the process. Calorie of the beverage is greatly lowered.

While the invention has been described in terms of preferred embodiments, those skilled in the art will recognize that the invention can be practiced with modifications within the spirit and scope of the appended claims.

What is claimed is:

1. A process of producing beverage comprising the steps of:
(1) washing cactus fruit and pitaya with clean water;
(2) drying the clean cactus fruit and pitaya;
(3) juicing the cactus fruit to obtain juice of the cactus fruit and juicing the pitaya to obtain juice of the pitaya respectively;
(4) filtering the juice of the cactus fruit and the juice of the pitaya respectively;
(5) mixing the filtered juice of the cactus fruit and the filtered juice of the pitaya with water to obtain a solution;
(6) pouring yeast and gram-positive bacteria in the solution wherein the yeast is saccharomyces boulardii and the gram-positive bacteria includes lactobacillus acidophilus and bifidobacterium longum; and
(7) fermenting the solution until beverage is produced wherein fermentation temperature is between 26° C. and 35° C. and fermentation time lasts for 3 to 10 days.

2. The process of producing beverage of claim 1, wherein the cactus fruit is the ripened ovaries of cactus.

3. The process of producing beverage of claim 1, wherein the cactus fruit is the peel of cactus.

4. The process of producing beverage of claim 1, wherein the pitaya is the ripened ovaries thereof.

5. The process of producing beverage of claim 1, wherein the pitaya is the peel thereof.

6. The process of producing beverage of claim 1, wherein a volumetric ratio of the filtered juice of the cactus fruit, the filtered juice of the pitaya, and water is 0.05-0.1:1-5:1-5.

7. The process of producing beverage of claim 1, wherein a volumetric ratio of saccharomyces boulardii, lactobacillus acidophilus, and bifidobacterium longum is 1-5:1-3:1-3.
